(19) United States
(12) Patent Application Publication
(10) Pub. No.: US 2018/0150864 A1
(43) Pub. Date: May 31, 2018

(54) Method and System for creating and comparing virtual firms

(71) Applicants: Kurt Robert KOLB, Burnaby (CA); Kazem Jahanbakhsh, Vancouver (CA)

(72) Inventors: Kurt Robert KOLB, Burnaby (CA); Kazem Jahanbakhsh, Vancouver (CA)

(73) Assignee: 0934781 B.C. Ltd, Vancouver (CA)

(21) Appl. No.: 15/673,342

(22) Filed: Aug. 9, 2017

Related U.S. Application Data
(60) Provisional application No. 62/373,172, filed on Aug. 10, 2016.

(51) Int. Cl. G06Q 30/02; G06F 17/30

(52) U.S. Cl. CPC G06Q 30/0223; G06Q 50/01; G06F 17/30864

(57) ABSTRACT

A system and method for creating a virtual service provider by associating separate service providers in a database. A search engine may compare individual service providers with the virtual service providers based on the aggregated attributes of the associated service providers. The virtual service providers are compared to needs, which needs are identified from historical data.

### BACKGROUND

Specialized databases and search engines exist to enable users to query and compare companies. These vary from general company databases (Yelp.com) to niche search engines (Adforum.com for marketing agencies). Advanced search queries often include attributes such as location, service class, product class, and size of the company. These are useful in order to focus the search on the user's requirements. However search results typically favor larger companies that can satisfy all of the requirements, simply because they have more locations, provide more services, more services, and their size gives them more capacity.

Smaller companies and individuals are less likely to be found using a simple search engine where several requirements must all be satisfied. This is often called the long-tail problem; large companies form the head of the ranked distribution with no trivial algorithm for surfacing small companies. More sophisticated search engines tend to rank providers by a count of their attributes, such as revenue, size, geographic reach, clients, capacity to handle work, popularity, reputation data that match the query—all of which favor bigger companies. Thus micro firms and freelancers appear at the bottom of any such ranking, if they are included at all.

The user is also likely to view small companies as offering less compared to bigger companies when the attributes are presented side-by-side. Smaller companies and individuals are often considered to be a lower-cost alternative because of their apparent lesser capabilities, even though they may be highly skilled in their niche area.

### BRIEF DESCRIPTION OF THE DRAWINGS

FIG. 1 is an illustration of connections between software agents of servers and client devices.

FIG. 2 is a block diagram of a computer system.

FIG. 3A is a graph of needs and service providers mapped to the same space.

FIG. 3B is an illustration of dot multiplication of Needs and Service Provider matrices.

FIG. 4 is an illustration of combinable or comparable service provider data objects.

FIG. 5 is a model of semantically related services and skills.

FIG. 6 is a flowchart for matching service providers and needs.

FIG. 7 is a flowchart for associating service providers.

FIG. 8 is an illustration of a model and module for processing data to recommend associations between service providers.

FIG. 9 is a webpage for displaying association recommendations to a user.

### SUMMARY

The inventors have appreciated an advantage in identifying a set of service providers to form a virtual firm, which is able to provide, in aggregate, services that match a Need. They have appreciated that the problem can be viewed as a type of graph selection optimization problem, which has nondeterministic polynomial complexity. Certain heuristics may be inventively applied to reduce the complexity to polynomial time.

According to a first aspect of the invention there is provided a computer-implemented method comprising: providing a database representing real-world service providers; one or more processor creating a plurality of virtual service providers, each virtual service provider created by associating, in the database, a plurality of the real-world service providers; the one or more processors determining features of each virtual service provider by aggregating features of the respective, associated real-world service providers; receiving, at a server, from a user, a search query for professional services; the one or more processor evaluating the aggregated features of the virtual service providers and features of other real-world service providers with respect to the search query to provide a set of search results to the user from the server.

The processors may compute similarity metrics between a feature vector of the search query and feature vectors of the virtual and other real-world service providers in order to rank the service providers for the search results.

According to a second aspect of the invention there is provided a database comprising a plurality of first data objects representing service providers and a plurality of second data objects representing a virtual firm of service providers, wherein at least two first data objects are connected in the database to each second data object. The database may be structured as a graph with first and second node types for first and second data objects and edges connecting first and second node types. The database may comprise a service index that returns a set of second data object identifiers for a given service feature.

According to a third aspect of the invention there is provided a computer-implemented method of creating virtual firms comprising: a processor identifying a plurality of needs for services from historical data and extracting a set of features of each need; providing a database comprising a plurality of service providers; the processor evaluating features of candidate combinations of service providers against features of the identified needs to identify a set of candidate virtual service providers; the processor creating associations, in the database, for certain of the candidate virtual service providers, each having the aggregated features of their respective, associated service providers.

The method may comprise a web server communicating the candidate virtual service providers to users for acceptance of the associations.

The associations may be created amongst those service providers for which respective users mutually accept the candidate combination.

Candidate combinations may be selected from service providers that are socially connected in a social network.

The method may comprise using machine learning to cluster groups of needs based on similarity of the features of the needs.

The database may be a social network of users, the method further comprising determining which of the users are service providers from the users' profiles.

The evaluation of service providers may return a fit score indicating how well the combined features of service providers fits the features of at least one of the identified needs.

The method may comprise calculating a weight for each need based on the frequency of historical data indicating that need and evaluating candidate combinations of service providers based on the weight of needs that they fit.

The method may comprise iteratively evaluating additional service providers to combine until an increase in the fit score is less than a threshold amount.

The historical data may comprise one or more of: past search queries for services, data about past projects, profiles of existing service providers.

According to a fourth aspect of the invention there is provided a computer implemented method comprising: identifying a plurality of needs; providing a social network comprising socially connected service providers; for a given first service provider; identifying second service providers having a social connection with the first service provider in the social network; comparing the combined features of the first service provider and at least one second service provider to one or more of the plurality of needs to identify a set of proposed second service providers to associate with the first service provider; outputting, over a communications network and to a client device of a user associated with the first service provider, proposed second service providers; receiving, over the communications network and from the user, acceptance or rejection of the proposed second service providers; and connecting the first and accepted second service providers in the social network, to create a virtual service provider.

The identified second service providers may be one hop or two hops from the first service provider in the social network.

Thus the system and method provide means for creating a structure to represent a plurality of providers and means to evaluate such providers as if they were a legal entity.

### DETAILED DESCRIPTION

A computer system and method are described to enable creation and evaluation of virtual firms, these being informal associations of a plurality of service providers but treated as if they were real firms. A database stores data about service providers, including freelancers, small firms, large firms and virtual firms. The system comprises computer processors and instructions to provide a search engine and other computer modules for manipulating data in the database. Notably certain modules combine service providers into a virtual firm and compare them with larger firms. Methods for operating the system to combine providers, maintain the database, make recommendations, retrieve data, aggregate attributes, and rank providers are discussed in detail below.

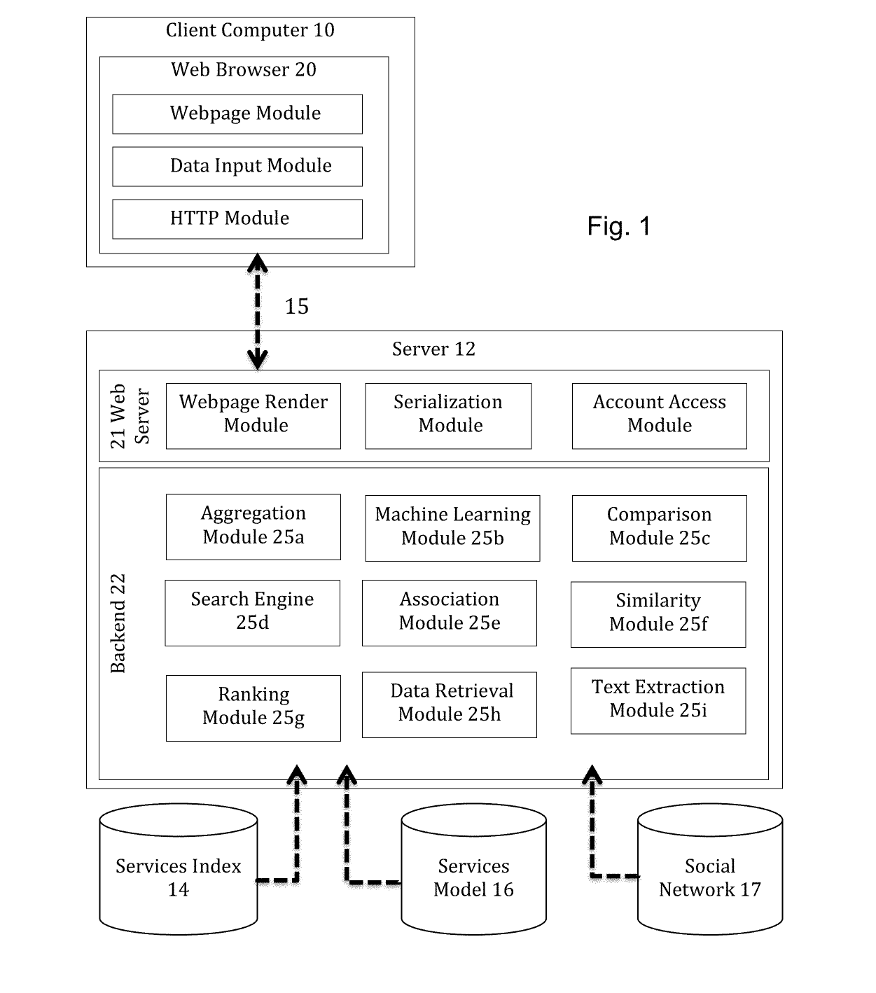

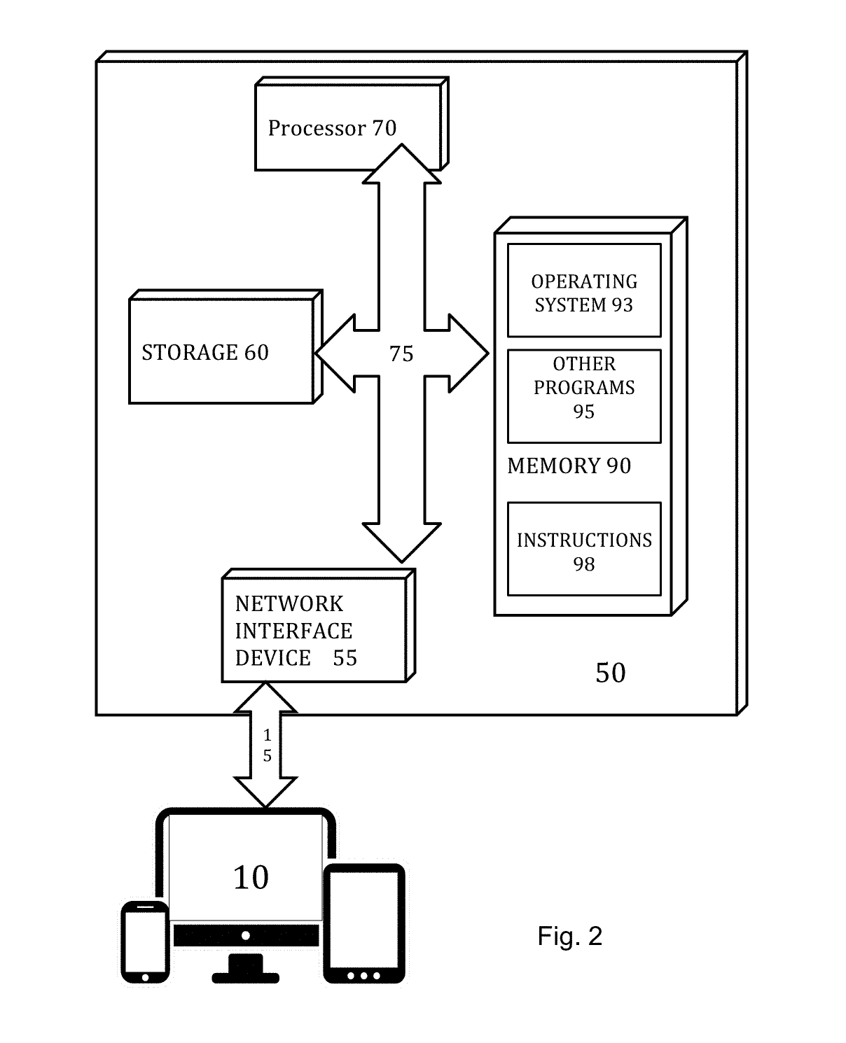

The present technology is implemented using computer system and computer processing methods. FIG. 1 is an illustration of software modules and FIG. 2 is a block diagram of computing components provided in a system enabling searching and data processing.

FIG. 1 illustrates the interaction between client-computing device 10 and the server 12 over network link 15. The device 10 may communicate via a web browser 20 or smartphone APP 19, using software modules to receive input from the user, make HTTP requests and display data. The communication is received at the server 12, 21 using an interface communicatively coupled to the network 15 to client computing devices 10, 11. The server 12 may be a reverse proxy server for an internal network, such that the client device 10 communicates with an Nginx web server 21, which relays the client's request to backend processes 22, associated server(s) and database(s) 14, 16 and 17. Within the server, software modules 25a-i perform functions such as, retrieve data, build and process data via service model(s), match requests and providers and calculate various score. Some software modules may operate within a notional web server to manage user accounts and access, serialize data for output, render webpages, and handle HTTP requests from the device 10.

FIG. 2 is a block diagram of an exemplary computer system for creating the present system and performing methods described herein. The system 50 includes a bus 75 for connecting storage 60, non-volatile memory 90, one or more processors 70 and network interface device 55. The memory contains software for the operating system 93 and instructions 98 and other applications as may be needed. The network interface device communicates over the Internet connection 15 with client device 10.

The one or more processors may read instructions from computer-readable memory 90 and execute the instructions 98 to provide the methods and modules described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

Users may access the databases remotely using a desktop or laptop computer, smartphone, tablet, or other client computing device 10 connectable to the server 12 by mobile internet, fixed wireless internet, WiFi, wide area network, broadband, telephone connection, cable modem, fiber optic network or other known and future communication technology using conventional Internet protocols.

The web server's Serialization module converts the raw data into a format requested by the browser. Some or all of the methods for operating the database may reside on the server device. The devices 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed network or over a cloud network.

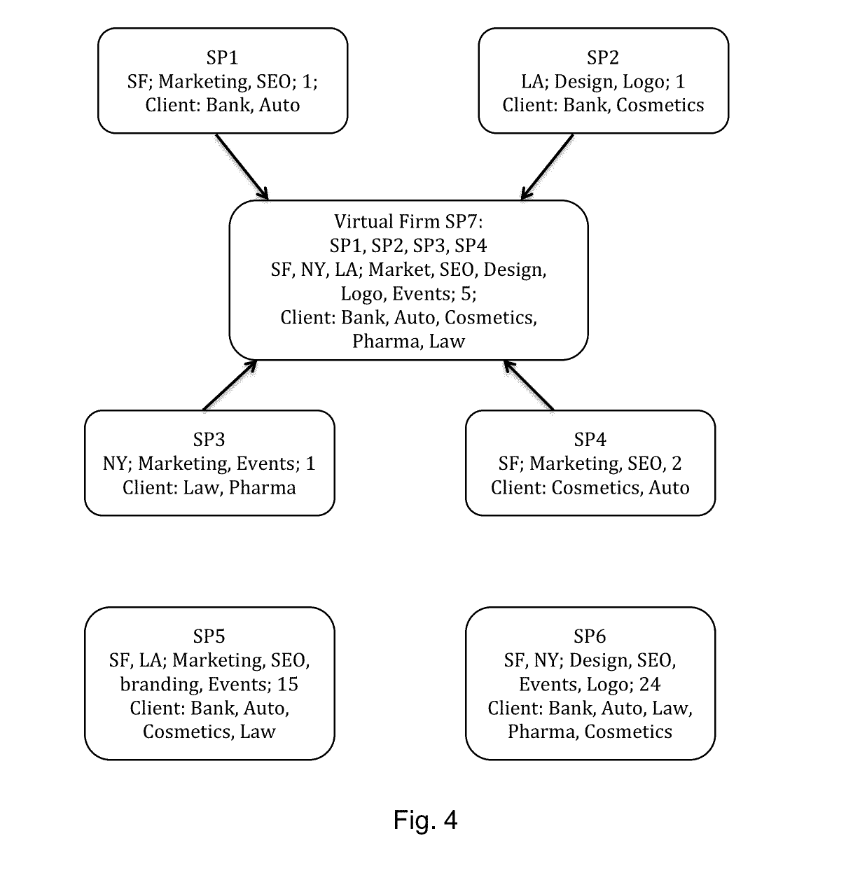

Consider the service providers, SP1-SP6, represented in FIG. 4, shown with their attribute values (location; services; employee count; client industries). Providers SP1-SP4 are small providers or freelancers having only one location, having experience in only a couple of client industries and offering two services each, whereas V5, V6 are larger and have multiple locations, clients and services each. A traditional search for “Marketing; Event Marketing; San Francisco; Cosmetic clients” would not find any of providers SP1-4 because none of them satisfy all requirements. A less strict, search and ranking engine might include SP1-4 but score each of them below SP5, SP6.

In the present system's search engine, the providers V1-4 are treated as a single virtual service provider, SP7, having the combined attributes of its members. The above search would return SP7 ranked highest, satisfying all the requirements and having the most relevant client experience and services.

### Database Format

The system includes a database storing data about service providers such as their name, location, services, and clients. These providers may be represented by data objects (such as a graph of nodes or relational tables) comprising tags, attributes and free-text descriptions. In a social network embodiment, each user has professional/social connections to multiple other users, organizations and projects. The skilled person will appreciate that the database structure is not a limiting factor of the invention and that other data structures would provide the same benefits as the embodiments described herein.

In certain embodiments, the database may be a graph having a plurality of nodes representing real-world service providers, some linked to Virtual Firm nodes representing a set service providers. A graph is a mathematical way of expressing relationships between objects. It may be implemented using indices, tables and lists, such as an index of node connected by a given edge type, an adjacency lists of all objects connected to certain nodes, a list of all objects within x hops from an object, a dictionary of related n-grams, or a matrix of all object-object connections.

As used herein, a virtual firm (aka meta-firm, super-firm, association, VF, or group) refers to a plurality of service providers that have been grouped together by the system. It is not intended to represent a legal partnership or corporation, nor need it have a physical presence. The members simply agree to be associated as a single (virtual) firm on a social network or directory. This gives individuals and small firms more visibility, capability, and capacity than they would have alone. An ‘association’ edge may be used to connect two service provider nodes together or connect a plurality of service provider nodes to a Virtual Firm node.

A service provider (also provider or SP) is a freelancer, company, agency, firm, or partnership that provides services to third parties. A provider may be described by their ‘capabilities’, i.e, their service tags, skill tags, client's industry and experience data. Attribute data includes these services, and skills; firmographic data, such as: location, size (revenue or employee count), customer type, organization type (startup, private, public, government or charity); and professional demographic data such as: age, education, seniority, job title, job function.

As used herein, past projects (also projects) refers to projects, case studies, awards, news articles, images, sample work, or other content that represents an example of a service provided by one organization for another organization. Project data objects may store image files, sound files, text descriptions, links to external documents, tags (services performed, project results, etc.), the organizations' identities, locations, costs, and time periods. The project data object may be a node connected by ‘contribution’ edges to service provider and client objects, said edges indicating whether each party contributed or received services.

Organizations are companies, corporations, partnerships, charities, firms, agencies, or government bodies. They may be both clients and service providers, but viewable in a particular situation depending on the direction of the edge connected them. A first organization node may be connected to a second organization node via a directed business edge to record a client-provider relationship.

Additional relationships may be assessed if the database includes employment data. This may be an employment graph, whereby employment edges connect employee objects and organization objects.

The term ‘social’ is used herein with reference to social networks and social connections to indicate relationships between data objects that represent shared personal and professional interests, activities, or real-life connections such as employment and friendship.

### Problem Complexity

While humans are capable of identifying a small set of people within their immediate social circle to tackle a project, their solutions are highly suboptimal when the requisite skilled person is outside this circle and as the number of people in the set increases. The human approach is also biased towards cronyism.

The present method enables discovery of opportunities to work together, beyond what can be found by people through close friends and luck. However, in a large social network, where there are millions of users and thousands of clusters of needs, the potential service provider combinations to suggest requires trillions of calculations to ensure that every combination of users and Needs have been considered and optimized.

Where k providers are selectable in a network of N providers to form a Virtual Firm, the possible combinations to evaluate increases factorially. The solution is thus NP-complex. In preferred embodiments, assumptions, thresholds and shortcuts are employed to reduce the number of combinations evaluated, resulting in a solution that computes in polynomial time. It will be appreciated that such assumptions and shortcuts are not necessary, as the brute force approach always remains an option. Nor must all of the assumptions, shortcuts and threshold be used. For example, the N providers may be reduced to a subset of providers according to some criteria. The k selected members may be fixed at an upper bound, preferably being a maximum of ten providers. Selection heuristics and set functions may be chosen to naturally limit the combinations possible or the k members even further. Given the huge number of service industries, service providers and potential combinations there arises a benefit to automate the Virtual Firm association process.

### Fit Function and Selection Heuristics

Assume a professional social network having 100,000 Needs, 10 million users, and a desire to create virtual firms of up to five persons. One or more reasonable approximations may be made to reduce the number of eligible provider nodes, paths or members k per virtual firm, such as:

1. Clustering the corpus of Needs into M Need Clusters, each cluster having a weight Wₘ corresponding to the proportion of Needs in that cluster.
2. Creating an index, first by services then by specialty services associated with Need Clusters, to reduce search times.
3. Only consider a Need Cluster when the first candidate offers at least one matching service (or more strictly, offers at least one matching service and has one other matching attribute).
4. Only consider second candidate providers that are one or two hops from member of the Set. One-hop candidates have the greatest mutual trust in each other, while two-hop providers are likely to include attributes (such as skills and services) that are different from each other. Higher degree connections have insufficient trust to form a firm together.
5. Only consider social contacts (second candidate providers) having: a) a social proximity greater than a threshold, THRₚᵣₒₓ or b) a Fit score with respect to the Need greater than a threshold, THR_{fit}.
6. Only consider the top J Need Clusters for a given first candidate. Alternatively, only consider Need Clusters closer than a threshold Fit score, THR_{fit}.
7. Only consider provider nodes that meet certain criteria, such as: being freelancers, being firms with less than five people, having services/skills or other features that correlate well with being service providers. This reduces the nodes n under consideration from hundreds of millions to potentially tens of millions.

Thus in the above example social network, there may be only 1000 indexed Needs Clusters compared on a single attribute type (i.e. services) to 100,000 service providers potentially in association with each provider's ten closest contacts. This reduces the potential combinations to compute to mere millions and scaling O(n).

The present system, via an Association Module (AM), employs code to a) select a set of nodes to evaluate b) quickly evaluate a function, Fit( ) for the set of nodes and c) test whether the set is acceptable in reality to the users and projects involved. Therefore, the AM will not need to check every combination of nodes and has some objective function for pruning the possible combinations.

The AM preferably starts with a seed node then grows the set one node at a time. The seed node may be a particular provider for whom recommended sets of providers are being generated. There may be a plurality of seed nodes chosen using a seeding function. The seeding function may identify a set of most active providers in the social-network. The seeding function may identify providers distributed across a variety of attribute values, particularly service values. The seeding function may identify a set of seed nodes that best match some target set of attributes. The seeding function may be a greedy function, such that only the top scoring seed nodes proceed to the next step.

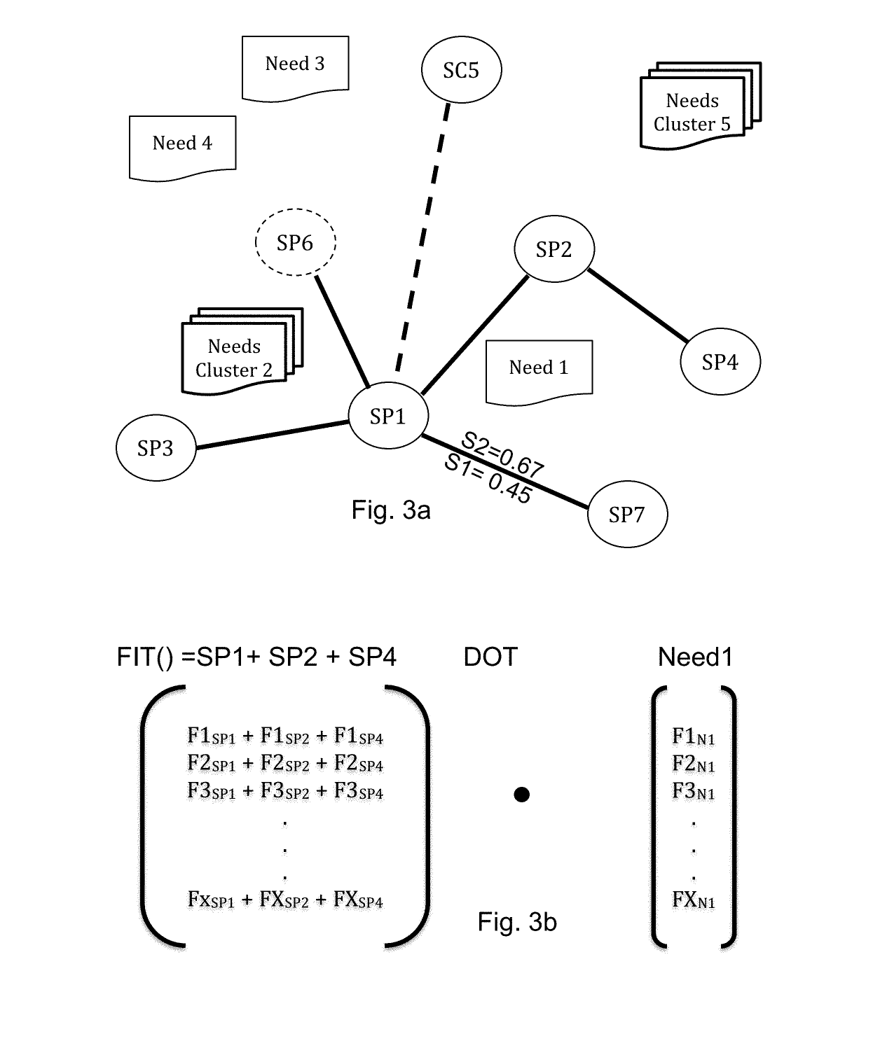

From each seed node, (see SP1 in FIG. 3a) the AM selects a plurality of second service provider nodes (candidates SP2-7). The AM evaluates the Fit function comprising the seed and one of the second providers.

This may require several hundred million computations but will at least finish in polynomial time. The number of second candidates to consider may be reduced greatly by using a diffusion model or heuristic, as discussed above, by limiting the candidates by their proximity to the seed provider. The proximity may be a weighted function of social interactions in the social network or simply limited to first- or second-hop graph connections in the social network (e.g. friends of seed nodes or friends-of-friends of seed nodes).

The node selection and Fit evaluation of third (then fourth, fifth, etc.) candidate nodes in association with the previous set of nodes is repeated as above to create candidate virtual firms. These subsequent candidate nodes may also be limited to one or two-hop connections in the social network to the existing members of the candidate virtual firm. To avoid carrying forward an exponentially growing set of candidate virtual firms, the AM preferably includes a Greedy or Hill-Climbing algorithm. This algorithm may carry forward to the next round, only the Y highest scoring candidate virtual firms (where Y may be the top five or top one candidate virtual firm(s)). Thus each next round requires O(n) processing time. The greedy algorithm thus calculates locally optimized combinations. Thus the algorithm need not consider every 5-person combination but only those that seem to improve the candidate virtual firm immediately.

Alternative heuristics for selecting seed and subsequent candidate provider nodes include the high-degree node heuristic (i.e. selecting nodes having the highest number of edges in the graph) or central node heuristic (i.e. selecting nodes known to be important or influential to other nodes, using Percolation centrality, Cross-clique centrality or Freeman centrality).

The Fit function preferably measures capability and probability of association of a set of candidate nodes in associating as a virtual firm. Capability may be calculated using the services model discussed herein. The probability of association may be calculated using proximity metrics in the social network. The Fit function may be coded to compare the set of providers to a target set of attributes. This target is herein called a Need, where Need and their attributes may be determined from past projects, search queries, project documents from a buyer, and/or existing real-world firms.

The Fit function is preferably a submodular set function. A submodular set function (also known as a submodular function or diminishing returns function) is a set function whose value, has the property that the difference in the incremental value of the function that a single member makes when added to the set decreases as the size of the input set increases.

The Fit function may be monotone in that adding a service provider to the set does not cause the Fit score to decrease. The AM stops adding candidate nodes to a candidate virtual firm at any round when there are no candidate nodes that increase the Fit score by more than a threshold amount.

Alternatively, the Fit function includes a negative term based on member-count to punish larger virtual firms. Such candidate virtual firms are discarded by the AM from further consideration, as they have a lower Fit score than the preceding, smaller set of nodes.

The AM may seek user-acceptance of a candidate virtual firm at the end of any round, preferably when the Fit score is above a threshold. The AM may continue adding new provider nodes to virtual firms that are bilaterally (or trilaterally) accepted by service providers. Advantageously this ensures that only those candidate virtual firms that are acceptable by the members are processed at the next round, rather than determining a local optimal firm of five members who refuse to associate. These candidate service providers receive a communication from the system, such as an email or notification when logged in, inviting them to accept a recommendation to connect with one or more other service providers. If the service providers agree to associate with each other, the system creates a Virtual Firm data object in the database.

The system assigns to the Virtual Firm data object the aggregate of each provider's attributes (aka features) such as location, size, revenue, services, skills, experience, projects, and clients. FIG. 3b (left side) illustrates a vector addition of features (F1-Fx) from three service providers.

### Identifying Candidate Providers

The present system, via an Association Module (AM), identifies a set of candidate service providers that are predicted to accept each other into a virtual firm and capable of meeting certain need. Rather than suggest all feasible combinations of providers, the AM calculates a probability that two or more providers will associate, then the AM algorithm makes recommendations based on this probability. The AM may use one or more of the following signal types:

i. complementary services, similar services, and similar attributes;

ii. sets of service and attribute requirements from buyers;

iii. social contacts such as friends, coworkers, followers;

iv. evidence of past co-working or mutual connection to past project data objects.

Signals i-ii may be seen as comparisons between data objects, whereas signals iii-iv are connections between data objects. For each signal type, the AM may process the data using a model to determine the strength of the respective signal. These signals may be weighted and combined to calculate an Association Score. The signals may be logically combined; for example, two providers must have a social connection to each other AND provide complementary services to be good candidates for association.

For signals of type (i) above, the AM retrieves from the service provider data objects experience, skill, and services data and then determines a similarity or degree of complementariness between the service providers. The system may maintain a service model to understand the relatedness between services and skills. The model may comprise a taxonomy, service/skill graph, topic model of services/skills, or semantic similarity look-up-tables.

The AM may assess similarity and complementariness between two service providers to return a first score S₁ to be used to recommend association between the providers.

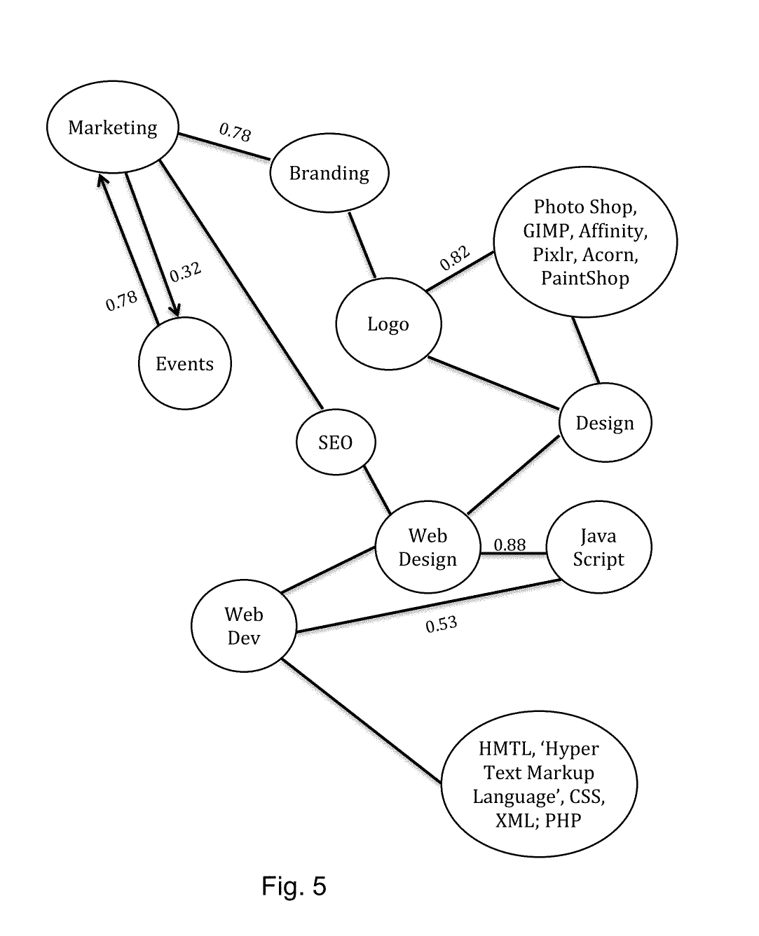

FIG. 5 shows a services model, as a graph comprising service feature nodes representing skill/service n-grams (some features are combined as synonyms or representing the same skills/services). Service feature nodes may be connected to indicate that they are similar or complementary. Some similarity scores are shown here.

In preferred embodiments, the services model is derived thru machine-learning. The AM may operate a feature extraction algorithm on each service provider profile to extract features and tag each with one or more service tags. A machine-learning algorithm of the AM may then learn services features (i.e. service tags, skill tags, and service keywords) commonly used together in profiles of service providers, both large and small. The machine-learning algorithm may also use past search queries, past projects, and existing firms to determine which requirements (e.g. skills and services) are often sought together in a search. For example, the AM learning algorithm may determine from the few providers of FIG. 4 that “Marketing” commonly appears with the service features “Search Engine Optimization (SEO),” “branding” or “events” but “events” only appears with “marketing”, thus the edge strengths may be asymmetric between the nodes “events” and “marketing” (see FIG. 5). The training data would contain thousands of example service pairings to average out noise and unusual pairings.

The AM machine-learning algorithm may count the number of times any pair of service features appears together, divide the count by the number of times that the particular service feature appears in order to normalize the count, and then record the semantic relation in a model (such as an edge in a graph), wherever the normalized count is greater than a threshold.

Alternatively the machine-learning module may consider other features to gain extra insight into relatedness between service features. The AM may comprise a topic-modeling algorithm, such as LDA, which operates on description text within provider profiles to discover latent topics. This algorithm computes the distance between two providers by computing and comparing their probability distributions over the latent topics. This distance metric is then used to estimate the distance (or inversely, the relatedness) between the service features of the two providers. The distance (or relatedness) is averaged across all the providers. Thus a set of providers with close distributions over latent topics and having a common service tag leads to the inference that the service tags are close which becomes the basis for forming the service model, such as a service graph.

For example, in the providers of FIG. 4, it may be calculated that many providers like SP3 and SP6 share highly overlapping topics from which the AM infers that the service features “Marketing” and “Design” are similar, despite those service features never appearing together in those providers themselves.

The machine-learning module then updates the model to: link these service features in a graph; increase the link strength between these service features; or cluster these service features together. In this way, the model may even record links between skills/services or discovers trends that are not recognized by experts.

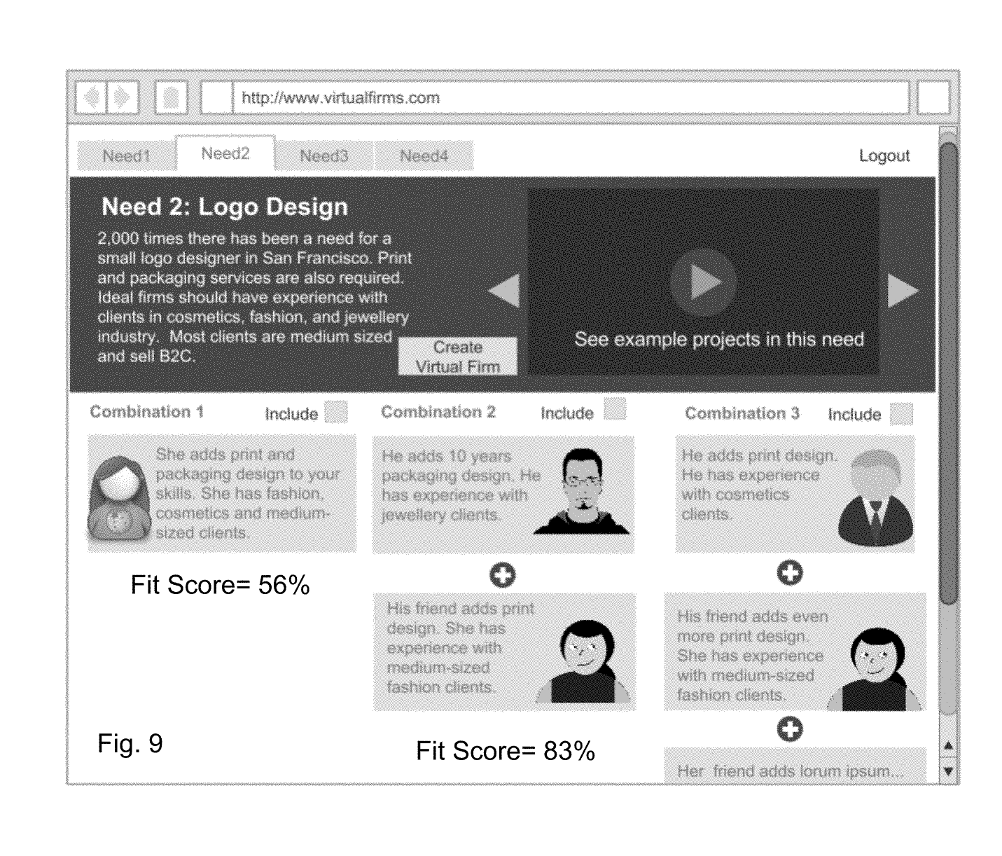

The AM may also use past searches/past project/existing firms, per signal (ii), to determine common attributes of Needs, which are thus expected to correspond to provider attributes. The AM searches the database for service providers that combine to satisfy the Needs. Rather than assume certain Need attributes, the Module discovers and learns these combinations unsupervised. The AM may train on thousands of past searches/past projects/existing firms to determine Needs clusters, each cluster comprising one or more values for each of a plurality of attributes. For example, as shown in FIG. 3a, Needs Cluster 2 corresponds to several Needs documents, which in multi-dimensional attribute space (e.g. locations, skills, industries) is close to SP3, SP1, and SP6. Need Cluster 2 is also described in Natural Language that is auto-generated to from the common attributes, as shown in FIG. 9. These Needs are clustered because hundreds of Needs are highly overlapped at certain attribute values, not necessarily because they were identical searches/projects/firms. Such calculations are discussed further below.

Per (i) above, the Association Module may also calculate a similarity of attributes in providers. Advantageously this increases the likelihood of wanting to work together if, for example, the location, education, and interests, etc. are similar. Preferably the attribute types to be compared for similarity are attribute types relevant to a Need (or Need Cluster).

Signals iii and iv measure social proximity and professional overlap, particularly to determine a probability that two or more candidates would agree to associate as a Virtual Firm. The AM traverses the database (e.g. a graph) to detect social or project connections between candidate providers. The connection may represent a variety of things, such as ‘friends’, ‘colleagues’, ‘followers’, ‘group members’, ‘messaging,’ ‘sharing of content,” and ‘project co-workers’. FIG. 3a shows a portion of a graph of providers connected to SP1 mapped to the same space as Needs 1-5.

Based on the existence and recency of connections between providers, the AM may calculate a social score S2 between providers. The social score algorithm may include 1) weights for each connection type with respect to its evidence of prior working together, 2) a sub-linear increase with the frequency of certain actions, and 3) an exponential decay based on the time t of the last action.

$${S}_{2} = {W}_{msg} \times log ( msg\_count ) \times {e}^{( - \frac{t 1}{τ} )} + Wcowork \times log ( duration ) \times {e}^{( - \frac{t 2}{τ} )} + … \qquad Equation 2$$

where W_{cowork} and duration are the weight and period that two freelancers worked together; τ is a decay rate; W_{msg} and msg_count are the weight and number of messages exchanged on the system, respectively. Additional factors could be added with their own weight and mathematical relationship.

The score S₂ is a measure of social proximity in a professional context. The algorithm for S₂ may also include logical expressions, for example requiring that two freelancers SP1, SP2: Have_worked_together(SP1,SP2) AND Are_close_socially(SP1, SP2). In certain embodiments, the AM may also calculate S₂ based on the number of mutual social contacts (friends and colleagues) they have.

Thus the AM evaluates the social score S₂ from data that indicates that two or more providers are likely to know each other and/or that that have worked together, with the latter being a stronger inductive predictor of accepting a proposed association. The AM may traverse the database per (iii) to identify that there is a social connection between first and second service providers or per (iv) to identify that first and second service providers were employed at the same time at an organization or contributed to the same project.

It may be particularly advantageous if certain embodiments of the AM require that two providers are candidates for association if they have both some evidence of a social connection AND similarity in their attribute data. That is S₁ and S₂ are both greater than a threshold value.

### Matching Service Providers to Needs

As discussed above, candidate service providers may be identified for association by comparing their attributes with a target set of attributes, which target may be set by a Need or Need Cluster. The Association Module may start from either a Need to find matching Service providers or from a Service provider to find a matching Need. From either starting point (Need or Provider), the AM identifies a plurality of matching objects (the other of a Need or a Provider) and then calculates a Fit score.

In one embodiment, the AM selects a Need as a target, then retrieves its features from the Need data object, and structures the features as a vector in the same vector space as the Providers to identify first providers (i.e. seeds). The AM may extract a primary feature, such as a service, of the target Need, which feature is found in a service index to return providers having that feature. These providers form the set of providers for consideration. These providers may be ranked using the Fit function to Greedily select a set of the closest providers to form the set of first providers (i.e. seed providers).

Conversely, a seed service provider could be initially selected, from which a primary feature is extracted, which feature is looked-up on the service index to return one or more relevant Needs. The Need with the highest Fit score with respect to the seed provider is Greedily selected as the target Need.

FIG. 3a illustrates Needs 1-5 and providers SP1-7 mapped to an arbitrary two-dimensional feature space. In this example, SP1 is the first candidate service provider. SP1 is capable of satisfying some of the features of Needs 1-5, with Needs 1-2 being the closest in feature space to SP1. Provider nodes SP2-7 have a graph path to SP1 and are potential second candidates. In this example, assume SP6 is not an active service provider and SP5 is further than a threshold proximity from SP1 (or below a threshold Fit for target Need1). Thus SP5 and SP6 are removed from further calculations.

The remaining service providers would potentially make a good combination with SP1 satisfying one of the target Needs (SP2,4,7 for Need1 and SP3 for Needs Cluster 2). The features of first candidate and each second candidates are combined, to evaluate which combination(s) best satisfy the candidate Needs Cluster's features.

The combination of Service Providers SP1, SP2 is compared to a target Need1, using the Fit algorithm, written in pseudocode as Fit(SP1+SP2, Need1). The algorithm preferably takes vectors of features and outputs a Fit score.

The Service Provider, combinations thereof, Needs, and Needs Clusters may store their features as a vector (F1, F2, F3 to Fx, where x may be ten to several hundred features). The vector includes service features, skills, locations, size, keywords/n-grams, and industries. The vector values may be (a) binary values representing the present or absent of a feature or (b) scalar values representing the strength of the feature for a given Provider or Need. Thus the example binary vector (1,0, . . . 1,0, . . . ) may represent that Need1 requires (logo design, no branding, . . . experience in cosmetics, no experience in automotive . . . ). Conversely the scalar vector (1,4, . . . 3,1, . . . ) may represent that Need1 requires (a small amount of logo design, a lot of branding, . . . moderate experience in cosmetics, minor experience in automotive, . . . ).

The combination of features of first candidate and each second candidate may be a linear combination, sublinear combination (e.g. log of added value), or logical combination (e.g. OR, AND). Logical combinations determine whether a feature is present in the combination of providers, which simplifies comparison to the Needs.

This Fit calculation may be a dot product of feature vectors of the Virtual Firm VF and the corresponding features of the Need (or Needs Cluster). See FIG. 3b. This is also known as cosine similarity and is a measure of the angle between the vectors.

Fit(VF,N)=cos(θ)=ΣₓVFx·Nx/\sqrt{ΣₓVFₓ²}×\sqrt{ΣₓNₓ²} Equation 3

The Fit algorithm may use other techniques such as computing the Jaccard index, Sørensen-Dice index, the Hamming and the Levenshtein distances, or the submodular set function. Thus the marginal Fit improvement that another service provider adds to the candidate virtual firm decreases as more and more providers are added.

A Jaccard index, also known as the Jaccard similarity coefficients, is a statistic used for comparing the similarity and diversity of sample sets. It measures the intersection of Virtual Firm and Need features divided by the union of their features.

$$Fit ( V F , N ) = J ( V F , N ) = \frac{{Σ}_{x} min ( {VF}_{x} , {N}_{x} )}{{Σ}_{x} max ( {VF}_{x} , {N}_{x} )} \qquad Equation 4$$

Sørensen-Dice index returns a statistic comparing the similarity between the Need and Virtual Firm. This index is similar to the Jaccard index.

$$Fit ( V F , N ) = Sv = \frac{2 \vert VF \cdot N \vert}{{\vert VF \vert}^{2} + {\vert N \vert}^{2}} \qquad Equation 5$$

The Hamming and the Levenshtein distances are metrics for measuring the difference between the two feature vectors (needs vs. candidate combination). The metric may be interpreted as the number of features of the combination that are missing from satisfying the need.

The features may be weighted to give some feature types given more importance than others, e,g the service match may be very important, the location may be quite important, and certain keywords only of minor importance.

The process is repeated for all providers as first candidate to receive a set of ranked second candidates for potential association there with.

In certain embodiments, the AM limits its candidates to providers that are individuals or smaller than a threshold size (e.g. by revenue or employee count). These providers are most likely to benefit from associations with others.

The skilled person will appreciate that the Association Module may extract and learn features for Needs from past search queries, past projects, and existing firms using a variety of techniques, and that there are corresponding techniques for comparing and evaluating candidate providers and to the Needs. For example Natural Language Processing, TF/IDF, and semantic relatedness models may be used on unstructured documents (of past projects, search queries and firm descriptions) to extract keywords and n-grams. Some of these keywords or n-grams correspond to features that are services, skills, locations, and industries. In structured documents and data objects of past projects, search queries and firms, the features are explicitly set. Clustering techniques, such as Topic modeling and Latent Dirichlet Allocation, may be used to find groups of Needs that are similar to each other according to a plurality of the features.

The Needs vector is preferably structured in the same way as the Provider and Virtual Firm vectors in order for them to be directly comparable.

### Flowchart

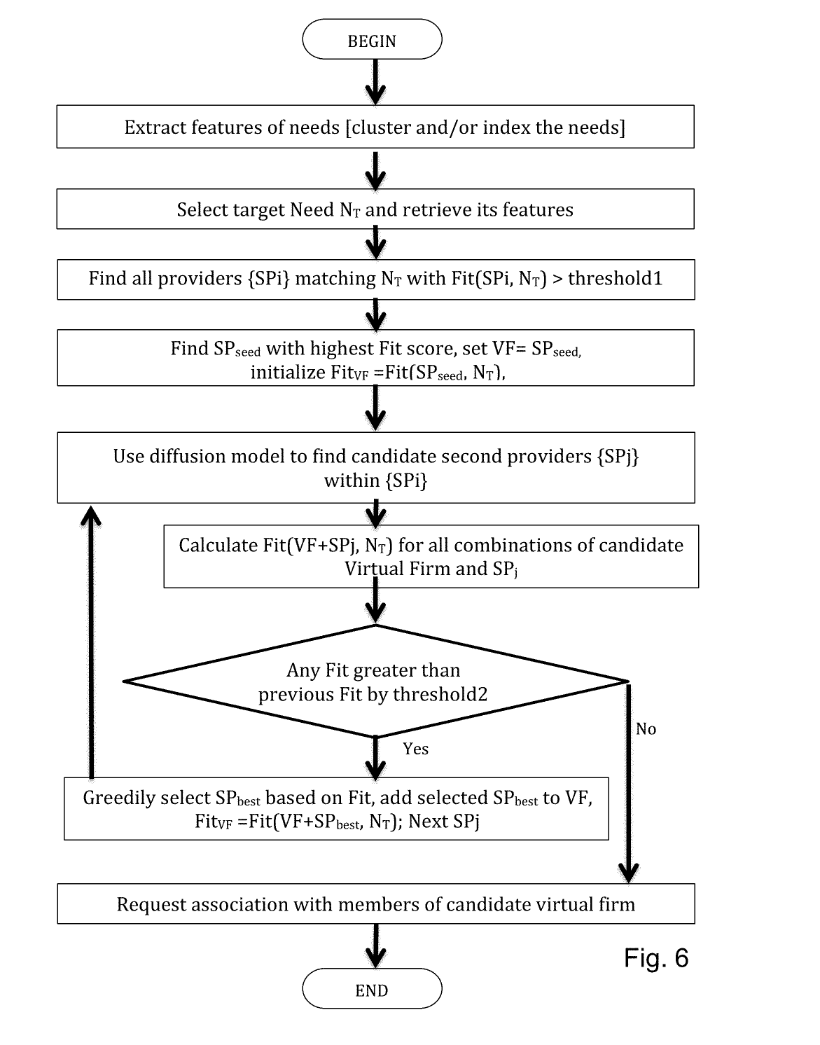

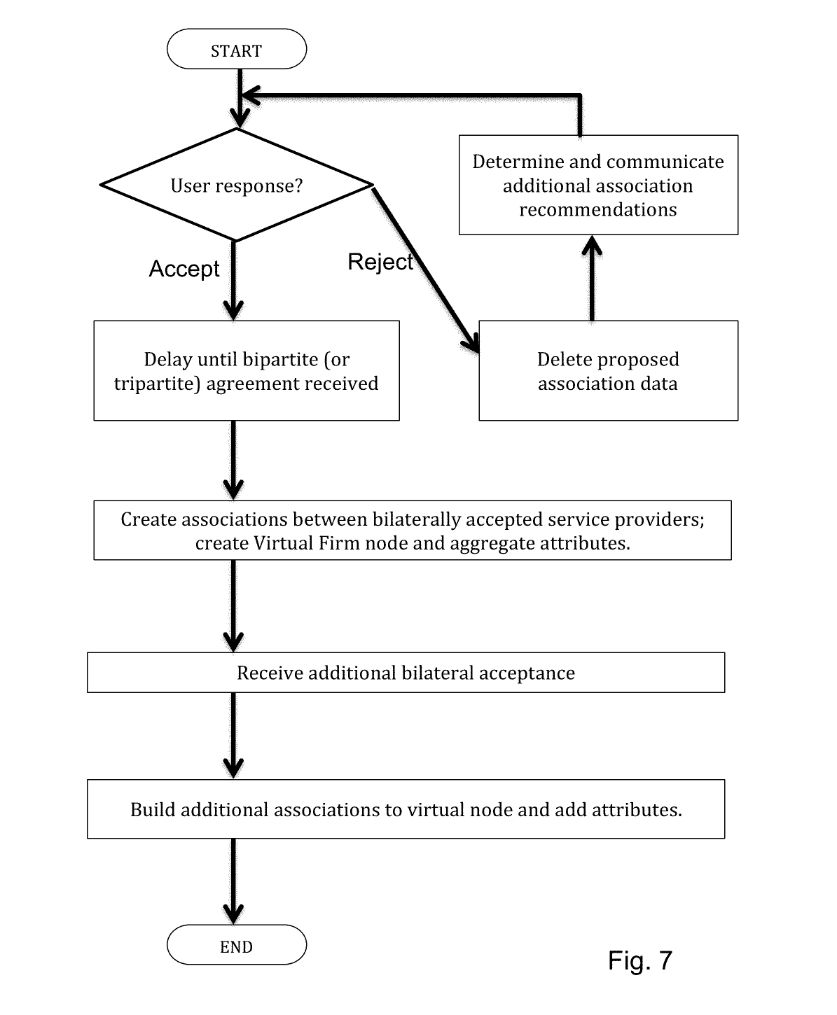

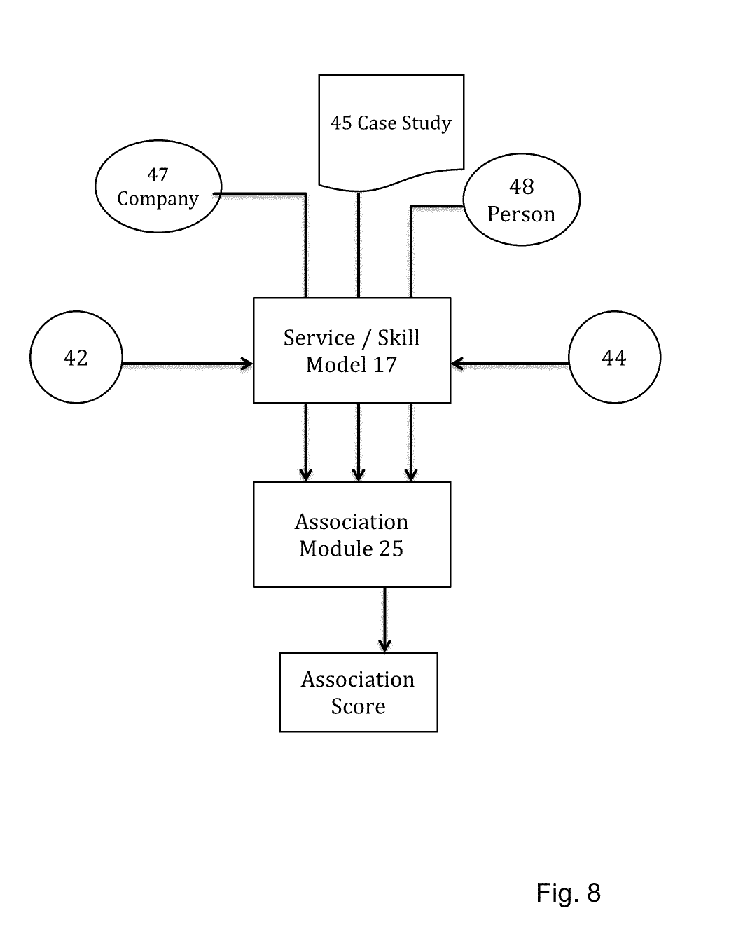

FIG. 6 illustrates an example order of operations for the Association Module. These steps and more are described below:
I. Extract features of all needs sources. Optionally cluster and index the needs.
II. Select a Need as a target Need, NT. Retrieve feature vector of NT from database.
III. Use service feature of N_{T} to find all providers SPᵢ in service index providing at least one service feature. Calculate Fit scores to remove SPi with less than threshold1 Fit score. The remaining candidates are sought within this set SPi.
IV. Reuse Fit score to Greedily select a seed provider, SP_{seed}.
V. Initialize VirtualFirm to include only SP_{seed}
VI. Initialize Fit_{VF} of the candidate virtual firm to Fit(SP_{seed}, NT)
VII. Use diffusion heuristics/model to identify second candidate providers SPⱼ within the set {SPi}
VIII. For each SPj, calculate Fitⱼ=Fit (VF+SPj, N_{T})
IX. Determine whether any new Fit score is greater than previous Fit score for the candidate virtual firm by at least a threshold amount. If so . . .
   a. Greedily select SP_{best} that has highest Fit score when combined with current candidate virtual firm.
   b. FitVF=Fit(VF+SP_{best}, NT)
   c. Add SPbest to the members of candidate virtual firm
   d. Go to step VII and select next provider SPj (excluding SP_{best}).
X. Else send requests to member of candidate virtual firm to associate with each other.

The iterations may terminate after a pre-determined k members have been added to create the candidate virtual firm. This process may be repeated to find other candidate virtual firms with different seed provider nodes and for different target Needs. The Greedy selection may select a fixed number more than one provider at any stage in order to explore optimal candidates that are not immediately suggested by the Fit function or diffusion model.

Thus for any target Need, the process stops when no provider increases the Fit score by more than a threshold margin. Optionally the system may determine and combine Fit scores of the best providers SP_{best} at each iteration with regard to a plurality of t target Needs, Nt, i.e. TotalFit=ΣFit(SP_{seed}+SP_{best}, Needₜ) over all t. This total score indicates how well a given second candidate would satisfy all of the Needs that the first candidate should be considering.

Many other approaches are possible with a different order of operations, calculation complexity, and optimized solutions. For example, instead of adding providers one at a time, the AM may consider all k-way combinations (3-way, 4-way, etc) of socially connected providers and select combinations with the best Fit scores.

In a simple example, where there is a single first candidate provider and a single Needs cluster for which they are qualified, the Association Module will identify their immediate social contacts that best fits that Needs cluster, in combination with the first candidate. Iteratively a third and fourth social contact may be added, provided each provides some marginal value over the previous iteration. There is marginal value at iteration t if Fit_{j,t}>C×Fit_{j,t-1}; for C greater than one.

If the first service provider is qualified for additional needs, additional virtual firms may be proposed. Alternatively, the features of all the Needs for which a first service provider is qualified are combined, and then a single virtual firm is proposed that best satisfies the combined needs.

### Large and Small Providers

Whilst the present method provides discovery of associations which are clearly beneficial to smaller service providers, the inventors have appreciated that in some cases a large firm and small firm would benefit from discovering synergy. Large service providers may be too large to compete on small projects or viewed as a bad match to small buyers. On the other hand, many small providers have niche skills/experience and are affiliated with larger providers, as consultants, ex-employees, or extra-capacity. However, the small providers have poor visibility and insignificant attribute values and thus get over-looked.

Using the above signals, associations between small and large providers can be discovered and accepted by each provider's administrative user. During a search for service providers, the attributes of the smaller provider may be displayed to a buyer to demonstrate the ability of the combined providers to handle smaller projects and smaller buyers.

The combined large and small provider may associate to offer different levels of service: small and personal services OR global and complex services. The methods may even be extended to multiple large firms that would benefit from providing a greater range of services across global markets to satisfy very large Needs.

### Recording Associations

The identified candidate virtual firms and their Fit scores may be stored in the database, preferably as an association graph comprising edges amongst candidate providers. These edges may be unidirectional or bidirectional and may indicate that the association has been accepted or merely suggested. Each provider node may be connected to a plurality of other provider nodes by these association edges. This recordation provides a ready source for real-time searching for a firm. Not only will the combined attributes be pre-calculated but also a representation of the virtual firm can be prepared for consumption by a searching user.

In certain embodiments, the web server communicates to a client-computing device of a user representing a service provider to request acceptance of the computed associations. The communication provides data about the ranked second candidates. The data may be provided as user profiles, company profiles, and an explanation for recommending the association. The User Interface (UI) provides interactive elements for the user to accept or reject the association. The web server receives the acceptance/rejection as input, which input is passed to the Association Module.

The AM may delete the association edge if it is rejected by one of the providers. Conversely, the AM may create a virtual provider data object if the proposed association is bilaterally accepted by both providers (or trilaterally for three proposed providers, etc.). The virtual provider data object is connected in the database to the associated provider data objects.

### Acceptance of Proposed Association

Another issue that can arise is a low probability of reaching bipartite, tripartite, etc. agreement in order to form a virtual firm. On solution is for the AM to implement heuristics, such as creating virtual firms even if less than all parties accept the proposal, the new virtual firm connecting only the accepting service providers. The AM may start with two-way virtual firms and then build to larger firms.

Another solution is to increase the number of proposed second candidates by including the second and third best fitting second providers (SP_{best}_{_}₂, SP_{best}_{_}₃) for each first candidates. This increases the chance than at least one bipartite, tripartite, etc. acceptance will happen to enable a virtual firm to be created. The users may rank their preferences in case of redundant acceptance, which the AM uses to arbitrate the final virtual firm.

### Aggregating Features

The system provides an Aggregation Module to aggregate features of each of the associated providers towards the virtual firm features. This may be done in real-time in response to a search for a service provider from a user but in preferred embodiments, the computation is done offline and stored with the virtual provider data objects.

The aggregation may be a simple combination of features of all associated providers or a weighted combination with strength values per feature. The simple combination technique adds together the features of each of the associated providers, removing duplicate features, to populate the appropriate fields of the virtual firm data object. FIG. 4 shows Virtual Firm SP7 with aggregates features of the associated Service Providers.

In a weighted technique, the features are extracted from each provider and optionally weighted based on frequency of features or evidence of features. The features and their weights are combined from all associated providers to populate the appropriate fields of the virtual provider data object. In this way, virtual firms may be ranked relative to other providers that also satisfy a search query, based on the relative strengths of the satisfying features.

The Aggregation Module may additionally link project, employee and client data objects of the associated providers to the Virtual Firm. Certain features of these data objects are extracted and aggregated towards the virtual provider. Thus the Virtual Firm receives credit for projects performed by its members, expertise/skills of employees of members, and industry relationships to clients of its members.

### Search Modality

The system provides a search engine 25d which receives a search query from a buyer-user's client-computer via a UI and web server. The search query may have free-text input and/or a plurality of desired search parameters, which act as filters to exclude providers or set biases for ranking providers. The search engine identifies from the database a set of service providers that each satisfies the search query. The service providers are scored with respect to the search query and a subset of the highest ranked providers are selected for output.

The search parameters preferably correspond to attributes of providers. The parameters/attributes may include: location(s), service(s) provided, size, industries served, awards, etc.

In the present system, the providers to be identified and compared include Virtual Firms alongside real-world firms. However, in the case of the Virtual Firms, the search engine uses the aggregated attributes. Therefore the system enables small firms and freelancers to compete with larger firms for projects

### Lead Provider Modality

The present system may also provide means for a lead service provider in the network to select a new project entered by a buyer and then receive recommendations from the system for candidate providers to co-work on that project. In this modality, the Association Module sets the (seed) service provider to this lead provider and the Fit function need only consider the selected project as the target Need. Social connectivity limits may also be set by the lead. Thus the number of combinations to evaluate and matches to compute is reduced considerably.

The system can select addition candidate providers that are closest in the graph to the lead and provide add some marginal improvement to the Fit with respect to the select project and relative to the lead provider. FIG. 9 illustrates a UI viewed by a lead provider, whereby Need2 is selected from four Needs to display the attributes of that Need and a plurality of sets of candidate providers to consider. The marginal attributes of each candidate and the total Fit Score is displayed to give context to the recommendation. As shown, each subsequent candidate adds a skill, service, experience or other attribute relevant to Need2 and increases the Fit Score in a diminishing returns fashion.

### Output of Results

Search results and proposals for associating service providers are communicated over a communications network to a client-computing device. The communications comprise digital representations of service providers, which may include images, attributes, text documents, names of providers, and computed scores.

As explained above, a set of providers are scored and selected for output to the client-computer of the buyer-user. Virtual firms may be represented by one or more of the service providers that make up the virtual firm. The representation may be that of a lead contact person assigned when the virtual firm was created offline. In certain embodiments, the provider(s) displayed to the buyer is/are the ones that most closely satisfy the search query. For example, an association of designers may satisfy a search for “logo designer in Seattle” and the individual provider that is displayed is the one that most specializes in logo design and that resides in Seattle.

The system prepares web content from the service provider data objects. A serialization agent serializes the web content in a format readable by the client-computer's web browser and communicates said web content, over a network, to a client's or vendor's computing device.

Display of a user means that data elements identifying a vendor are retrieved from a user profile object in the database, serialized and communicated to client computing device 10, 11 for consumption by the user. Display of a project document may similarly be made by displaying the text from the document or a multi-media file (e.g. JPEG, MPEG, TIFF) for non-text samples of project.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “/” (the slash mark) between alternatives is to be understood in the inclusive sense, whereby either alternative and both alternatives are contemplated or claimed.

Reference in the above description to databases are not intended to be limiting to a particular structure or number of databases. The databases comprising documents, projects, business relationships or social relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third party databases and agents.

For the sake of convenience, the example embodiments above are described as various interconnected functional modules. This is not necessary, however, and these functional modules may equivalently be aggregated into a single logic device, program or operation. In any event, the functional modules can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method comprising:
providing a database representing real-world service providers;
one or more processor creating a plurality of virtual service providers, each virtual service provider created by associating, in the database, a plurality of the real-world service providers;
the one or more processors determining features of each virtual service provider by aggregating features of the respective, associated real-world service providers;
receiving, at a server, from a user, a search query for professional services;
the one or more processor evaluating the aggregated features of the virtual service providers and features of other real-world service providers with respect to the search query to provide a set of search results to the user from the server.

2. The method of claim 1, further comprising the one or more processors computing similarity metrics between a feature vector of the search query and feature vectors of the virtual and other real-world service providers in order to rank the service providers for the search results.

3. A computer-implemented method of creating virtual firms comprising:
a processor identifying a plurality of needs for services from historical data and extracting a set of features of each need;
providing a database comprising a plurality of service providers;
the processor evaluating features of candidate combinations of service providers against features of the identified needs to identify a set of candidate virtual service providers;
the processor creating associations, in the database, for certain of the candidate virtual service providers, each having the aggregated features of their respective, associated service providers.

4. The method of claim 3, further comprising a web server communicating the candidate virtual service providers to users for acceptance of the associations.

5. The method of claim 4, wherein the associations are created amongst those service providers for which respective users mutually accept the candidate combination.

6. The method of claim 3, wherein candidate combinations are selected from service providers that are socially connected in a social network.

7. The method of claim 3, further comprising using machine learning to cluster groups of needs based on similarity of the features of the needs.

8. The method of claim 3, wherein the database is a social network of users, the method further comprising determining which of the users are service providers from the users' profiles.

9. The method of claim 3, wherein said evaluation of service providers provides a fit score indicating how well the combined features of service providers fits the features of at least one of the identified needs.

10. The method of claim 3, further comprising calculating a weight for each need based on the frequency of historical data indicating that need and evaluating candidate combinations of service providers based on the weight of needs that they fit.

11. The method of claim 9, further comprising iteratively evaluating additional service providers to combine until an increase in the fit score is less than a threshold amount.

12. The method of claim 3, wherein the historical data comprises one or more of: past search queries for services, data about past projects, profiles of existing service providers.

13. A computer implemented method comprising:
identifying a plurality of needs;
providing a social network comprising socially connected service providers;
for a given first service provider;
identifying second service providers having a social connection with the first service provider in the social network;
comparing the combined features of the first service provider and at least one second service provider to one or more of the plurality of needs to identify a set of proposed second service providers to associate with the first service provider;
outputting, over a communications network and to a client device of a user associated with the first service provider, proposed second service providers;
receiving, over the communications network and from the user, acceptance or rejection of the proposed second service providers; and
connecting the first and accepted second service providers in the social network, to create a virtual service provider.

14. The method of claim 13, wherein the identified second service providers are one hop or two hops from the first service provider in the social network.
